(19) United States
(12) Patent Application Publication
(10) Pub. No.: US 2012/0260792 A1
(43) Pub. Date: Oct. 18, 2012

(54) PRODUCTS AND METHODS FOR BALLISTIC DAMAGE MITIGATION AND BLAST DAMAGE SUPPRESSION

(76) Inventors: Ronald Grossman, Buffalo, NY (US); Thomas Harris, Maple Grove, MN (US)

(21) Appl. No.: 13/280,080

(22) Filed: Oct. 24, 2011

Related U.S. Application Data
(60) Provisional application No. 61/415,607, filed on Nov. 19, 2010.
(60) Provisional application No. 61/447,959, filed on Mar. 1, 2011.
(60) Provisional application No. 61/468,196, filed on Mar. 28, 2011.

(51) Int. Cl. F41H 5/04; E04F 13/00; B32B 43/00

(52) U.S. Cl. 89/36.02; 156/98; 156/71; 89/915; 89/920

(57) ABSTRACT

This invention is directed to energy absorbing or dissipating composite materials used to reduce structural damage from explosive blast energy and ballistic projectiles, either separately or in combination, and to methods of employing such materials. More particularly, this invention is directed to a blast damage suppression and/or ballistic shielding material comprising at least three independent layers; a layer comprising fiber based panels; a spray foam coating material and a coating layer comprising an elasto-plastic material.

### CROSS REFERENCE TO RELATED APPLICATIONS

This invention claims domestic priority from U.S. Provisional Patent Application Ser. No. 61/415,607, filed Nov. 19, 2010. This invention also claims domestic priority from U.S. Provisional Patent Application Ser. No. 61/447,959, filed Mar. 9, 2011. This invention also claims domestic priority from U.S. Provisional Patent Application Ser. No. 61/468,196, filed Mar. 28, 2011. The disclosures of these applications are hereby incorporated herein by reference.

### FIELD OF THE INVENTION

This invention is directed to energy absorbing composite materials used to reduce structural damage from explosive blast energy and ballistic projectiles, either separately or in combination, and to methods of employing such materials.

Ballistic shielding materials are designed to protect structures and personnel inside such structures from a range of ballistic threats including sniper fire, high-caliber projectiles and explosive fragments from mortars, rocket-propelled grenades (RPGs), shaped charges and/or improvised explosive devices (IEDs), to name but a few of the common ballistic threats.

Blast damage suppression materials are designed to dissipate a proportion of the energy from explosions in order to further protect structures and personnel inside such structures from the damage that is caused by energy produced from explosives. Additionally, the combination of materials in this invention will prevent the ricochet or “splash-back” of fragments and projectiles by containing these either inside or close by the surface of the composite. The suppression of the damaging effects of an explosive blast will serve to at least partially protect structures and the personnel inside such structures from the effects of the explosive blast.

### BACKGROUND OF THE INVENTION

Current structural techniques for the reduction of collateral blast and/or ballistic damage caused by exploding flying debris for roofing applications include the use of high mass materials (e.g., concrete pavers, in large “squares”) placed directly onto the insulated or un-insulated roof deck. The application of such technology is limited to low-slope roofs and those roof structures capable of sustaining the substantial additional deadload of the materials.

In other infrastructure applications, such as light-weight walls and temporary protection barriers, typical construction materials such as plywood and/or metal siding are used as physical barriers to prevent penetration by ballistic projectiles. These solutions are generally inadequate from a protection standpoint and can also result in additional projectiles being involved as the protection barriers themselves are destroyed.

Polymer compositions and composite materials have been used in the past as blast and/or ballistic shielding materials. See for example the following documents which are hereby incorporated herein by reference:

U.S. Pat. No. 7,794,808 discloses an elastomeric damage-control barrier. This invention uses soft polyurethane within a tube over metal, such as for pipeline protection.

U.S. Pat. No. 7,687,147 which discloses polymeric compositions for use in preparing a ballistic shielding material.

U.S. Pat. No. 6,806,212 discloses a coating and method for strengthening a structure, based on two polyurethane layers with a layer of a textile imbedded between them.

U.S. Pat. No. 5,580,651 discloses an energy absorbing panel, for instance, a door panel for a vehicle or boat, consisting of polyurethane foam core 1.5 to 24 lbs/cu ft. with a higher tensile strength flexible reinforcing layer—added to the mold prior to pouring the foam in the mold.

U.S. Pat. No. 3,866,242 discloses a protective shield made from a polyurethane elastomer made from a cyclo-aliphatic version of MDI. The product was sold under the trademark “Adiprene”.

U.S. Patent Publication No. 2010-0173117 which discloses polymeric compositions for use in preparing a ballistic shielding material.

U.S. Patent Publication No. 2009-0145288 discloses impact resistive composite materials and methods for making the same. This invention uses an elastomer “front face” and an impact resistive substrate.

U.S. Patent Publication No. 2007-0036966 which discloses a blast energy mitigating composite. This invention discloses a blast energy mitigating composite containing “energy mitigating units contained in an energy mitigating matrix”.

U.S. Patent Publication No. 2004-0067352 discloses rigid composite building materials and assemblies utilizing porous and non-porous rigid foamed core materials.

GB Patent No. 2288764 discloses the use of a foamed plastic as a load bearing supporting layer.

GB Patent No. 1534721 discloses protective material for resisting penetration by bullets, shrapnel, or the like, made from high density polyurethane foam>10 lb/cu ft. consisting of two layers with a polyamide or fiberglass sheet in between.

As indicated above, some of the known protective techniques use a polyurethane elastomer and/or a polyurea elastomer, applied directly to the substrate being protected. Also some of these techniques use polyurethane foam inside of a panel as an energy absorbing barrier.

### SUMMARY OF THE INVENTION

One embodiment of the present invention is directed to a shielding material for ballistic protection and/or blast damage suppression, comprising at least three independent layers; a layer comprising fiber based panels; a cellular foam material selected from spray-applied or liquid-applied, and a coating layer comprising an elasto-plastic material selected from spray-applied or liquid-applied; wherein the composite shielding material does not shatter when struck with a ballistic projectile.

The materials employed in the shielding material may be spray applied and/or liquid applied. Liquid applied includes a material that is poured in place in-situ during the preparation of the shielding material, and further includes a material that is produced by a liquid pouring process elsewhere, and thereafter used for assembly into a shielding material.

Another embodiment of the present invention is directed to a ballistic shielding material comprising a composite of a sprayed polyurethane foam (SPF) having a density in the range of from about 1.5 to 8 lbs per cubic foot, applied to an existing substrate, and further protected with a spray applied polyurea coating which may be either reinforced or non-reinforced. This SPF material can be rigid or semi-flexible, insulating or non-insulating.

Yet another embodiment of the present invention is directed to a blast damage suppression material comprising a composite of a sprayed polyurethane foam (SPF) having a density in the range of from about 1.5 to 8 lbs per cubic foot, applied to an existing substrate, and further protected with a spray applied polyurea coating which may be either reinforced or non-reinforced. This SPF material can be rigid or semi-flexible, insulating or non-insulating.

Advantageously, the blast damage suppression and ballistic shielding materials of the present invention have sufficient thickness such that the material does not shatter when struck with a ballistic projectile, with or without the added force of an explosion. In other words, projectiles are preferably stopped by the shielding material, or the velocity thereof is greatly reduced by impact with the shielding material, and the shielding material itself does not, when impacted, turn into additional harmful projectiles.

In preferred embodiments of both the blast damage suppression and ballistic shielding materials, the SPF and polyurea coatings are applied over fiber based (e.g., fiberglass) panels. One preferred fiberglass panel is made with a thermosetting polymer resin mix (such as DERAKANE MOMENTUM brand resins commercially available from ASHLAND) and multiple layers (depending on composite thickness) of fiberglass fabrics consisting of woven rovings (such as ROVCLOTH brand from FIBER GLASS INDUSTRIES, INC), are compressed together to create panels such as HARDWIRE HS ARMOR brand from HARDWIRE LLC that will absorb large amounts of impact energy. These relatively lightweight fiberglass panels are used as storm-resistant and ballistic damage resistant building panels in place of more traditional building materials such as plywood and/or concrete blocks.

Embodiments of the blast damage suppression and/or ballistic shielding systems of the present invention thus comprise a number of fiberglass reinforced resin composite panels, mounted to a substrate (e.g., a building, tent, or similar structure to be protected) preferably in a direction facing against the object to be protected—for example vertically to protect the vertical wall of a building or piece of equipment or horizontally against the surface of a roof; followed by a coating comprising from about 2 to 6 inches of SPF (2 lb to 6 lb density) covered with another coating of from about 50 to 500 mils of polyurea.

In certain embodiments of these blast damage suppression and/or ballistic shielding systems, each fiberglass panel employed is at least about 0.5 inches thick, with from about 2 to 3 inches of 3 pound density SPF and 150 mils of a polyurea coating. The polyurea coating is further protected from U.V. rays by use of a thin 20 to 30 mil acrylic coating, typical for this type of application (polyurea-SPF) in outdoor situations. Other U.V. protective coatings include silicone, polyurethane, and the like.

Thickness of the fiberglass panels can vary depending upon the desired level of protection desired. Fiberglass panel thicknesses of less than 0.5 inches are lighter in weight and can be used where this factor outweighs the lowered level of protection provided. Similarly, fiberglass panel thicknesses of more than 0.5 inches are heavier in weight and these can be used where this factor, and the enhanced level of protection provided, is desired.

It is expected that the polyurea and SPF will add the following properties to the fiberglass composite panel:
(a) It will decelerate the bullet or projectile, allowing the system to resist larger or higher velocity projectiles than either part alone.
(b) It will re-direct the bullet or projectile to turn or change the angle of flight, making the system more ballistic-resistant.
(c) Larger, contiguous panels can be made by connecting a multitude of fiberglass composite panels—using the SPF-polyurea system as a unifying common coating, keeping in mind that the polyurea can be either below or above the SPF—or both.
(d) Larger panels, acting as a continuous piece, are expected to be more blast-resistant, since the entire macro-panel will act to spread the energy of the blast over a larger area.
(e) The peak energy and over-pressure blast from explosions are dissipated by the SPF-polyurea system.
(f) Fragments from either the explosive device itself, or from near-by unprotected structures and vehicles are blocked from further ricochet or “splashback” due to being captured or de-energized by the SPF-polyurea system.

The fiberglass composite panel adds the following enhancements to the SPF-polyurea system:
(a) Adds reinforcement to the base to increase the ballistic-resistance of the system
(b) Absorbs more of the ballistic energy to increase the ballistic resistance of the SPF-polyurea system
(c) Provides a uniform surface to which to apply the SPF-Polyurea material
(d) Enhances the construction of the system vertically, since the SPF-Polyurea material is attached to a surface that can now be mounted vertically.

In certain embodiments of the blast damage suppression and/or ballistic shielding systems of the present invention, the polyurethane foam can be at least about two inches in thickness. In certain embodiments the polyurethane foam can be at least about three inches in thickness. In certain embodiments the polyurethane foam can be at least about four inches in thickness. In certain embodiments the polyurethane foam can be at least about five inches in thickness. In certain embodiments the polyurethane foam can be at least about six inches in thickness.

In certain embodiments the blast damage suppression and/or ballistic shielding material further comprises an additional layer of another protection coating, which may optionally be fiber-reinforced. Preferred materials for this protection coating include polyurethane and/or polyurea coatings. This layer provides one or more of the following benefits; energy absorbing and reflecting layer, strengthens the substrate/foam composite dramatically due to its combination of high tensile strength and elasticity, and it enables an optional reinforcement layer to be incorporated into the composite. This layer has a thickness that ranges from 0.030 to 0.500 inches, preferably from 0.065 to 0.500 inches; more preferably from 0.120 to 0.500 inches, and most preferably about 0.500 inches.

Specific polyurethane, polyurea, and epoxy types and commercial manufacturers include; Specialty Products Incorporated, DRAGONSHIELD BC, DRAGONSHIELD HT ERC, K5 ULTRA HIGH STRENGTH, POLYSHIELD various products; Burtin Urethane PAXCON PX-3350, PAXCON PX-2100, LINEX; PolyCoat of American Polymers Corp: POLYEURO various products; United Coatings TERRATHANE and ELASTUFF products, Reichold EPOTUF, and the like. These products differ from the existing sprayed polyurethane foam (SPF) protective coating technology applied as an outer layer for TerraStrong® foam insulation as follows:
(a) Higher thickness of the protective coating resulting in surprising anti-ballistic properties. Traditional SPF protective coatings have a thickness of less than 40 dry mils (0.040 inches).
(b) Higher strength compared to the traditional protective coatings used.
(c) Traditional protective coatings do not include any reinforcement materials in the coating, whereas, reinforcement can be employed for ballistic damage mitigation.
(d) Traditional protective coatings are not employed under the SPF layer, whereas, for ballistic damage mitigation, the placement can be made at such a location.
(e) Higher density foam; traditional roofing foam is 2.2 to 3.0 pounds per cubic foot density, and wall foam is 0.5 to 2.2 lbs/cu. ft. density.
(f) Higher foam flexibility range compared to traditional roofing foam; from viscoelastic to flexible to semi-rigid.

In certain embodiments the polyurethane and/or polyurea coating is applied to the exposed or outside surface of the polyurethane foam. In certain embodiments a polyurethane, polyurea, or epoxy coating is applied to the non-exposed or inside surface of the polyurethane foam. In certain embodiments the coating is applied to both the exposed and the non-exposed surfaces of the polyurethane foam.

Another embodiment of the present invention is a method of protecting structures from blast and ballistic damage comprising coating said structures with a ballistic shielding material as described herein. In certain embodiments the structures are selected from the group consisting of military buildings, bunkers, tents, and the like.

As used herein, the term “polyurethane” is understood to cover the family of polymeric materials that contain a polyurethane polymer structure (i.e., the reaction product of an isocyanate and a polyol) but may also contain varying amounts of other isocyanate-derived structures, including polyisocyanurate (PIR).

### BRIEF DESCRIPTION OF THE DRAWINGS

The drawings accompanying this specification relate to the testing of a preferred embodiment of the ballistic shielding material of this invention, as conducted by the Southwest Research Institute (SwRI).

FIG. 1 illustrates various (FSP) Fragment Simulating Projectiles (units in mm), −20 mm, 0.50 cal, 0.30 cal.

FIG. 2 illustrates the SwRI Test Gun System used herein.

FIG. 3 illustrates the SwRI chronographs used for velocity measurements.

FIG. 4 shows the 0.50 cal Testing Configuration used herein.

FIG. 5 illustrates the Target Strike (Left) and Back (Right) Post-Test.

FIG. 6 shows the Target Side View, detailing a tear from Test 4 and the bulge size from Test 5.

FIG. 7 shows the detail of Back Face Damage in Test 4.

### DETAILED DESCRIPTION OF THE INVENTION

As described above, this invention is directed to energy absorbing composite materials used to reduce structural damage from explosive blasts and/or ballistic projectiles, and to methods of employing such materials.

The shielding materials of the present invention are designed to protect structures and personnel inside such structures from a range of blast and/or ballistic threats including sniper fire, high-caliber projectiles and explosive fragments from mortars, rocket-propelled grenades (RPGs), shaped charges and/or improvised explosive devices (IEDs), to name but a few of the common threats.

Blast damage suppression materials are designed to suppress the damaging effects of explosives, including at least the partial dissipation of the blast shock wave; and/or at least the partial absorption of blast energy; and/or at least the partial retention of blast debris. The suppression of the damaging effects of an explosive blast will serve to at least partially protect structures and the personnel inside such structures from the effects of the explosive blast.

Since 2008 Honeywell International Inc. has sold polyurethane foam materials for the manufacture of insulating materials under the trademark TerraStrong®. This material has now been found to be useful in creating the ballistic damage mitigation system of this invention. Other materials that may likewise be useful in this invention, include, but are not limited to, the following examples; polyester resin and fiberglass fiber shell material, isocyanurate spray foams, visco-elastic polyurethane foams, semi-rigid foams, polyurea, high density elastomers, and cementious coverings, and the like. Preferably, the ballistic damage mitigation material used herein comprises a closed cell polyurethane insulating material, most preferably, Honeywell's TerraStrong® material.

Blowing agents are typically employed for the spraying of polyurethane materials and such blowing agents preferably have low global warming potential (GWP) and/or low ozone depletion potential (ODP). Blowing agents preferably have an ODP of not greater than about 0.5 and even more preferably an ODP of not greater than about 0.25, most preferably an ODP of not greater than about 0.1; and/or a GWP of not greater than about 150, and even more preferably, a GWP of not greater than about 50. One commercial blowing agent with zero ODP is Enovate® from Honeywell (245fa), and this is the preferred material used in the present invention.

This invention exploits one of the key properties of the polyurethane spray foam, namely the ability to be applied as a sprayable liquid and to conform to the shape of the substrate. As for blowing agents, all liquid blowing agents can be used, for example, 245fa, 365mfc, 365mfc/227ea mixtures, 141b, 1233zd(E) or 1233zd(Z), 1336mzzm(Z), water and less preferred—cyclopentane, isopentane, normal pentane, methyl formate, methylal, trans-1,2-dichloroethylene and gaseous blowing agents like 134a, 1234ze(E), and CO₂. Any and all mixtures of these agents will also be suitable.

As described above, TerraStrong® is a trademark for Honeywell products known conventionally as closed-cell spray polyurethane foams (ccSPF). Included in this product line are insulating materials, protective coatings, and waterproofing materials. TerraStrong products have been employed in military operations for use as insulating materials for buildings and tents since 2008. TerraStrong material insulates temporary and permanent military structures, including tents, living units, office spaces and other structures to decrease air, dust, and noise infiltration.

In 2010 it was found that, when applied as taught herein, TerraStrong materials can serve as more than mere insulating materials for military buildings, tents and other structures. When applied as taught herein, TerraStrong materials, and similar materials, can also serve as ballistic damage mitigation products for buildings, tents and other structures.

One embodiment of the blast damage suppression and/or ballistic shielding material of the present invention thus comprises the fiberglass reinforced resin composite panel, mounted to a substrate (e.g., a building, tent, or similar structure to be protected) preferably in a direction facing the object to be protected, followed by a coating comprising from about 2 to 3 inches of SPF (21b to 61b density) covered with another coating of from about 40 to 500 mils of polyurea.

In certain embodiments of the blast damage suppression and/or ballistic shielding material system, each fiberglass panel employed is at least about 0.5 inches thick, with from about 2 to 3 inches of 3 pound density SPF and 150 mils of a polyurea coating. The polyurea coating is further protected from U.V. rays by use of a thin 20 to 30 mil acrylic coating, typical for this type of application (polyurea-SPF) in outdoor situations. Other U.V. protective coatings may be used such as silicone, polyurethane, and the like.

Thickness of the fiberglass panels can vary depending upon the desired level of protection desired. Fiberglass panel thicknesses of less than 0.5 are lighter in weight and can be used where this factor outweighs the lowered level of protection provided.

In certain embodiments, the present invention provides a ballistic damage mitigation system comprising a composite of materials; first one or more fiberglass panels are mounted on the substrate to be protected. Next, a light-weight, fully adhered foam material, together with a second coating material is added to the fiberglass panels, thereby forming a unified ballistic damage mitigation system.

In most blast damage suppression and/or ballistic shielding material embodiments the system adds around 2 to 8 pounds per square foot of deadload to the underlying structure, while providing a substantial degree of flying projectile damage protection. Since all of the components of the system are light-weight materials, the components do not present an additional destructive threat if they become airborne when a projectile strikes the system. In addition, the foam and coating composite provide insulation (R-6/inch) value while in service, resulting in energy savings in the order of 20%-50% depending upon the application.

### Foam Alternatives

In addition to the preferred TerraStrong® polyurethane foam, other foams having similar desired properties, including a density of from 0.5 to 10 pounds per cubic foot, can be employed in this invention. Such foams can be in the form of open or closed cells. Energy absorbing foams may also include foams that are visco-elastic, flexible and/or semi-rigid materials, known in the art. In addition to spray foam materials, the shielding material of the present invention may comprise a cellular liquid-applied foam material, such as polyurethane and/or polyurea. One preferred liquid-applied foam material comprises a layer of polyurethane. Another preferred liquid-applied foam material comprises polyurea.

### Coating Materials

In addition to the preferred TerraStrong® spray coating materials, other coating materials can be employed, either under or on top of the foam layer, or both; and that the coating could consist of one or more layers. Suitable coating materials include polymers from the chemical types known as acrylic, silicone, EPDM, polyurethane, polyurea, epoxy, or combinations thereof, and these coating materials may further contain non-polymer materials such as surfactants, fire retardant liquid and solid materials along with other active and non-active fillers and colorants, known in the art. These coating materials may be used as structural components of the system and/or as thin U.V. protective coatings, as desired.

### Ballistic Fabric and Reinforcement Materials

In some embodiments, the fiberglass panels can further comprise one or more additional or alternative ballistic protective fibers or fabrics. Known ballistic fibers include, for example, materials such as aramid and high-modulus polyethylene (HMPE) fibers and textiles. These materials are especially useful in the military applications of the present invention.

Honeywell's ballistic fibers and fabrics include Gold Shield, Spectra Shield® and Spectra Shield II materials. Spectra Shield and Spectra Shield II use Honeywell's super-strength Spectra® fiber, which, pound for pound, is 15 times stronger than steel yet light enough to float. The Spectra Shield® II ballistic composite material uses HMPE fibers. The Gold Shield® armor material uses aramid fiber. See also, U.S. Patent Publication No. 2008-0118639.

DuPont's Kevlar® aramid ballistic shielding materials are offered in several versions to protect against bullets, sharp objects, shrapnel, or a combination of threats. Kevlar XP™, a woven/laminated construction that offers attributes of both woven and unidirectional technologies.

DSM Dyneema, makes Dyneema® ballistic fibers and yarns, which comprise an ultra-high-molecular-weight polyethylene (UHMWPE), for use as ballistic shielding materials. Specific products include HB51 and HB26. Warwick Mills uses Dyneema® and other high-performance fibers to provide bullet resistance and blunt trauma protection in soft armor incorporating its TurtleSkin® SoftPlate technology.

Milliken & Company makes Tegris™ polypropylene (PP) thermoplastic composite as a ballistic textile. This technology is based on a coextruded PP tape yarn with a highly drawn core sandwiched between layers of lower-melt polymer.

Innegrity LLC offers Innegra™ S PP-based ballistic shielding materials for both hard and soft armor applications. Other ballistic fabric products include fiber products based on nanotechnology. Nanocomp Technologies Inc., produces fibers made from carbon nanotubes, in yarn and nonwoven sheet form.

### Comparison of Features:

(a) Provides insulation—the current coating/re-enforced coating offering does not.
(b) Provides waterproofing—the current offering does not.
(c) Provides an energy absorbing/dissipating layer of polyurethane foam—the current offering does not.
(d) The high-strength polyurea coating provides a highly effective layer of protection for foam insulation—the current offering of foam and coating in use today, utilizes a “low-strength” protective coating designed to reflect sunlight, not ballistic projectiles.
(e) Lightweight 2 to 8 lb. per sq. ft)—the current high mass offering is >15 lb./sq ft.
(f) Fully adhered (distributes uplift and explosion-energy over a wide surface)—the current high mass offering is not adhered to the substrate.
(g) Fully adhered (will not become airborne)—the current high mass offering is loose (becomes a projectile itself).
(h) Flexible—reflects and dissipates force rather than transferring force to the substrate.
(i) Spray applied—can be applied to all substrates horizontal or vertical—current high mass offering is a heavy stone/concrete square restricted to flat horizontal surfaces.
(j) Raw material shipped directly to application site in drums (easy to handle/dispose and use)—current high mass offering is heavy, bulky and not easy to transport.
(k) Material expands about 15 to 30 times its volume during manufacture (a little product goes a long way)—current high mass offering of pavers requires shipping the “finished good”.

### How to Make and Use:

For existing roof applications, clean the substrate to remove all dust and loose material for the substrate. Apply the fiberglass panels to the substrate in sufficient quantity to provide the desired level of protective coverage—preferably 100% coverage. Apply a minimum thickness of two inches TerraStrong Insulating Foam. Within 24 hrs., apply the TerraStrong Blast/Ballistic protective coating—a polyurethane and/or polyurea outer coating as described above—at the thickness desired for the given installation. Repeat this process for walls, or other substrates. Note—the protective performance will vary with the foam thickness, coating thickness and type.

Steps employed for adding blast damage suppression and/or ballistic protection to existing TerraStrong insulated structures include:
(a) Remove all dust, dirt debris by hand or air wand.
(b) Confirm minimum foam thickness of two inches in all areas, and add additional foam if necessary.
(c) Remove and repair all areas of damaged coating.
(d) Confirm no areas of delaminated coating; repair if necessary.
(e) Prepare substrate and protect adjacent areas using industry standard techniques.
(f) Apply blast/ballistic protection system components—(1) fiberglass panels; (2) polyurethane foam and (3) polyurea coating.

Steps employed for adding blast damage suppression and/or ballistic protection to existing insulated roof decks:
(a) Remove high mass pavers if present.
(b) Remove all dust, dirt debris by hand or air wand.
(c) Prepare substrate and protect adjacent areas using industry standard techniques.
(d) Apply the fiberglass panels and then apply two inches (minimum thickness) of TerraStrong Insulation directly to the prepared substrate.
(e) If required, apply additional inches (2 to 5 inches thick) of energy absorbing spray polyurethane foam as determined by desired level of protection.
(f) Within 24 hours apply the blast/ballistic protection coating composite either fiber reinforced or an un-reinforced coating, depending on the desired level of protection.

Steps employed for adding insulation and blast damage suppression and/or ballistic protection to un-insulated/protected structures:
(a) Remove all dust, dirt debris by hand or air wand.
(b) Prepare substrate and protect adjacent areas using industry standard techniques.
(c) Apply the fiberglass panels and two inches (the minimum thickness) of TerraStrong Insulation directly to the prepared substrate.
(d) If required, apply additional inches (e.g., from 2 to 5 inches thick) of energy absorbing spray polyurethane foam as determined by desired level of protection.
(e) Within 24 hours apply the blast/ballistic protection coating composite—either fiber reinforced or the coating alone—depending on the desired level of protection.

Steps employed for adding additional blast damage suppression and/or ballistic protection to the above applications of roof decks and other un-insulated/protected structures:
(a) To the prepared existing substrate, apply the fiberglass panels.
(b) Prior to the application of the initial two inches of TerraStrong Insulation, apply a layer of the ballistic protection coating composite, either fiber reinforced or the coating alone—from a thickness of 0.050 inches (50 mils) to the desired thickness of up to 0.50 inches (500 mils). In certain embodiments, a thickness of at least about 0.10 inches (100 mils) is used. In certain embodiments, a thickness of at least about 0.25 inches (250 mils) is used. In certain embodiments, a thickness of at least about 0.40 inches (400 mils) is used. In certain embodiments, a thickness of at least about 0.50 inches (500 mils) is used.

### Test Data

Honeywell contracted with the Southwest Research Institute (SwRI) to conduct ballistic testing against a sample of the shielding material of this invention. Ballistic testing was conducted using the 0.50 cal fragment simulating projectile (FSP). One sample was provided by the Honeywell and a total of five (5) test shots were taken during the course of this testing. The following details the technical procedures used to evaluate the armor designs and the associated test results.

### Shielding Material Sample

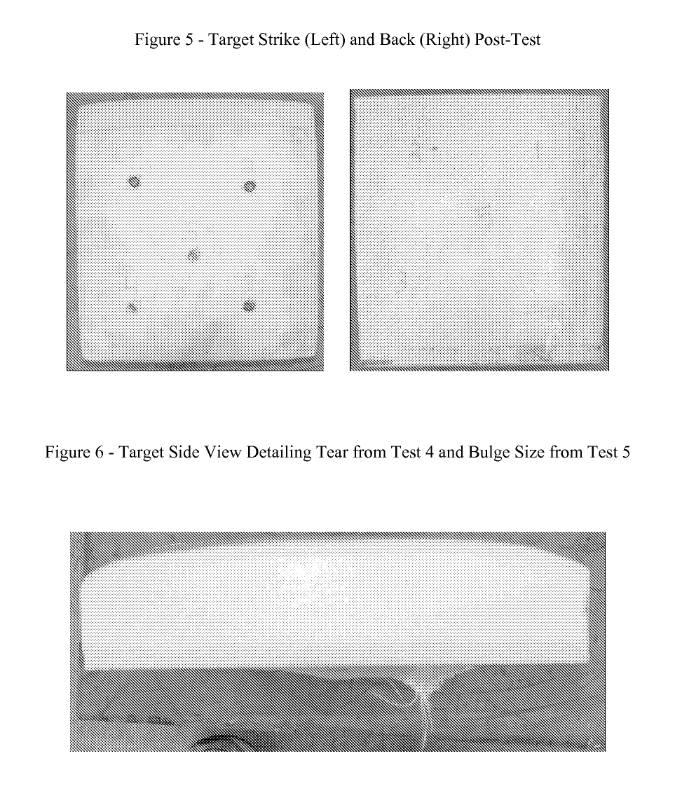

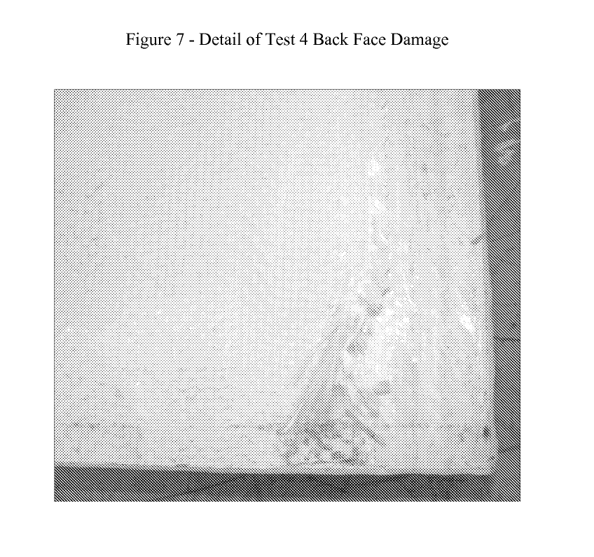

Honeywell provided a single armor design for evaluation. The target was approximately 12-inches×13-inches, with a rounded strike face which brought the thickness of the sample to approximately 3-inches at the center. The target was constructed of a ballistic foam material with a composite backing. Specifically, the armor included an 0.50 inch e-glass composite board made by Hardwire LLC; 2 inches of TerraStrong spray polyurethane foam—approximately 3 lb density; 150 mils of DSBC polyurea spray-applied elastomer made by Specialty Products, Inc. and 20 mils of TerraStrong acrylic elastomer. See, FIGS. 5, 6 and 7.

### Shot Pattern

The shot pattern was not specified in the request for testing. Based on the sample size, and the size of the threat round, a 6-inch×6-inch square shot pattern was chosen. Five shots were placed in the pattern: one at each corner of the square (for a total of 4 shots), and one at the center.

### Threat Round 0.50 cal FSP

The 0.50 cal FSP was manufactured according to MIL-P-46593A. These hardened steel projectiles are machined out of 4340 steel and have a blunt nose. They are commonly used to simulate fragments formed during the detonation of cased munitions. The 0.50 cal FSP weighs 207 grains with an overall length of 0.582-inches and a main body diameter of 0.495-inches. Tolerances for the FSP can be found in MIL-P-46593A. A typical 0.50 cal FSP is shown in FIG. 1.

### Test Methodology

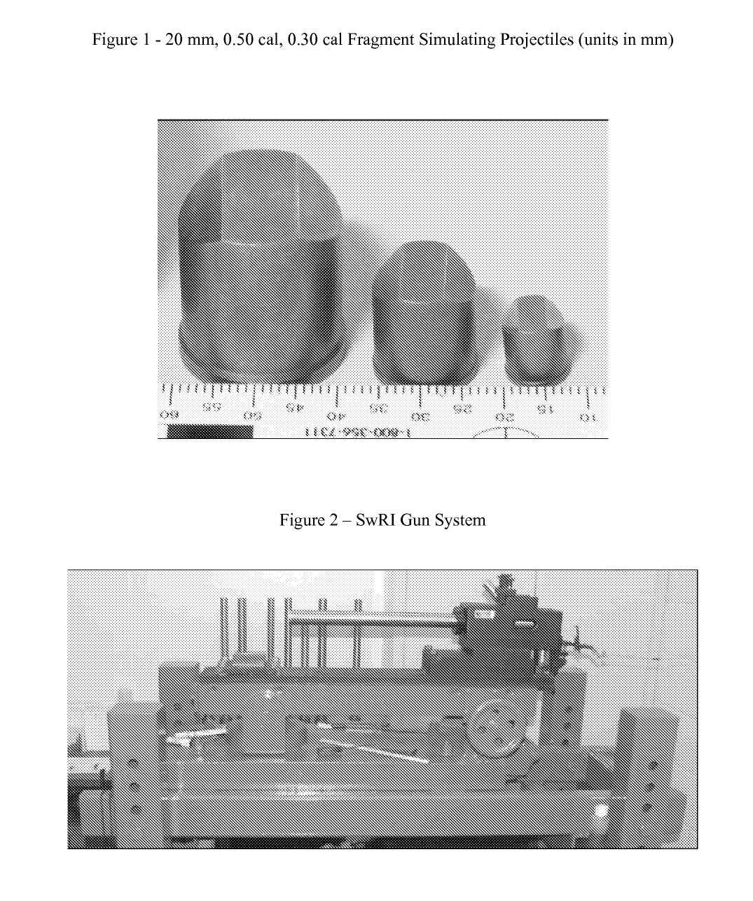

A universal gun mount was used to hold the rifled barrels used during the course of this testing. The SwRI Small Arms Range was utilized for this test program. The particular gun system is shown in FIG. 2. A bore aligned laser was used to line up the gun with the desired impact locations on the target and to confirm target obliquity. For safety reasons the gun was fired remotely by pulling a steel lanyard.

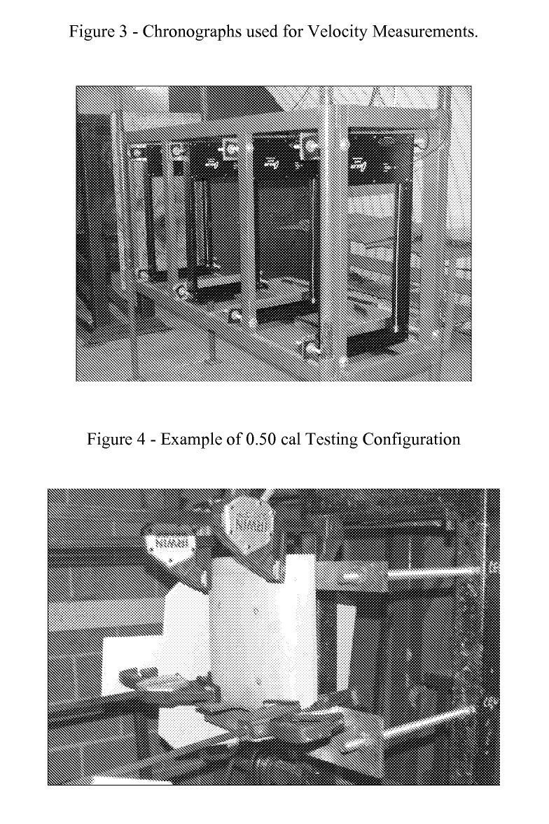

Projectile impact velocities were measured using two sets of Oehler Model 57 photoelectric chronographs located between the gun mount and the target fixture (FIG. 3). The spacing between each set of chronographs was 59 inches. Calibrated Hewlett Packard HP 53131A universal counters, triggered by the chronographs, recorded the time it took the projectile to travel between chronographs. Projectile velocity was then calculated using the recorded times and the known travel distance. An average of the two calculated velocities was recorded as the screen velocity. A Vision Research Phantom V7.3 high-speed video camera was also utilized to obtain residual velocities when the target was perforated.

The SwRI Small Arms Range is a climate controlled facility. All testing for this program was conducted with the target being stored at room temperature (−75° F.).

### Target Holders

The target was as held as shown in FIG. 4. The target holder was constructed out of two long horizontal supports which were clamped to a large, massive frame. The bottom support had a lip on it to prevent the target from falling downward. The target was centered on the opening in the target holder which was 10 inches. This provided a 1-inch overlap on the bottom, and a 2-inch overlap on the top. The target holder and target were clamped together at each of the four corners with 16-inch Quick-Grip clamps.

### Test Results

As specified by Honeywell, the starting velocity for this target was around 1,000 fps. The strike velocity was then increased until a fail was recorded. After the first three shots, the target held up well, with no material cracking on the outer surface, and only a small bulge on the rear face.

On Test 4, at a velocity of 1,692 fps, the target failed. A residual velocity of 589 fps was recorded based on the high speed video taken during the test. On the back face, a material tear appeared, running vertically above and below the shot location. Damage on the fifth and final shot was similar to Tests 1-3, with a medium sized bulge appearing on the back face of the target. A two shot V₅₀ of 1,571 fps with a spread of 242 fps was calculated using shots from Test 4 and 5. Table 1 shows the cumulative results for this series of tests. FIGS. 5-7 show the target condition post-test.

TABLE 1
Cumulative Results for Tests 1-5

| | Velocity | | Residual Velocity |
|---|---|---|---|
| Test # | (fps) | Pass/Fail | (fps) |
| 1 | 1,010 | Pass | 0 |
| 2 | 1,082 | Pass | 0 |
| 3 | 1,328 | Pass | 0 |
| 4 | 1,692 | Fail | 589 |
| 5 | 1,450 | Pass | 0 |

While the present invention has been particularly shown and described with reference to preferred embodiments, it will be readily appreciated by those of ordinary skill in the art that various changes and modifications may be made without departing from the scope of the invention. It is intended that the claims be interpreted to cover the disclosed embodiment, those alternatives which have been discussed above and all equivalents thereto.

What is claimed is:

1. A ballistic shielding material comprising at least three independent layers; a layer comprising fiber based panels; a cellular foam material selected from spray-applied or liquid-applied, and a coating layer comprising an elasto-plastic material selected from spray-applied or liquid-applied; wherein the composite shielding material does not shatter when struck with a ballistic projectile.

2. The ballistic shielding material of claim 1, wherein the elasto-plastic material comprises polyurea, polyurethane or epoxy.

3. The ballistic shielding material of claim 1, wherein the liquid-applied foam material comprises a layer of polyurethane.

4. The ballistic shielding material of claim 1, wherein the liquid-applied foam material comprises polyurea.

5. The ballistic shielding material of claim 1, wherein the spray-applied foam material comprises a layer of polyurethane.

6. The ballistic shielding material of claim 1, wherein the spray-applied foam material comprises polyurea.

7. The ballistic shielding material of claim 2, wherein the polyurea, polyurethane or epoxy coating is applied to the exposed or outside surface of the polyurethane foam.

8. The ballistic shielding material of claim 2, wherein the polyurea, polyurethane or epoxy coating is applied to the non-exposed or inside surface of the polyurethane foam.

9. The ballistic shielding material of claim 2, wherein the polyurea, polyurethane or epoxy coating is applied to both the exposed and the non-exposed surfaces of the polyurethane foam.

10. The ballistic shielding material of claim 5, wherein the polyurethane foam is at least about two inches in thickness.

11. The ballistic shielding material of claim 5, wherein the polyurethane foam is at least about three inches in thickness.

12. The ballistic shielding material of claim 5, wherein the polyurethane foam is at least about four inches in thickness.

13. The ballistic shielding material of claim 5, wherein the polyurethane foam is at least about five inches in thickness.

14. The ballistic shielding material of claim 5, wherein the polyurethane foam is at least about six inches in thickness.

15. The ballistic shielding material of claim 1, further comprising a ballistic fabric material.

16. The ballistic shielding material of claim 15, wherein the ballistic fabric material is directly applied to the elasto-plastic material or polyurethane foam.

17. The ballistic shielding material of claim 15, wherein the ballistic fabric material is directly applied to the coating material.

18. A method of protecting structures from ballistic damage comprising coating said structures with a ballistic shielding material of claim 1, said method comprising the steps of:
remove dust, dirt and/or debris;
confirm a minimum foam thickness of two inches in all areas, and add additional foam if necessary;
remove and repair any areas of damaged coating;
confirm no areas of delaminated coating; repair if necessary;
apply the fiber based panels to the substrate; and
apply sufficient ballistic shielding material to the substrate, wherein said material may be fiber reinforced or un-reinforced, depending on the desired level of protection.

19. The method of claim 18, wherein the structures are selected from the group consisting of buildings, bunkers, and tents.

20. A structure protected by the method of claim 18.

21. The structure of claim 20, wherein the structure is selected from the group consisting of buildings, bunkers, and tents.

22. A blast damage suppression material comprising at least three independent layers; a layer comprising fiber based panels; a cellular foam material selected from spray-applied or liquid-applied, and a coating layer comprising an elasto-plastic material selected from spray-applied or liquid-applied; wherein the composite shielding material does not shatter when struck with a ballistic projectile.

23. The blast damage suppression material of claim 22, wherein the elasto-plastic material comprises polyurea, polyurethane or epoxy.

24. The blast damage suppression material of claim 22, wherein the liquid-applied foam material comprises a layer of polyurethane.

25. The blast damage suppression material of claim 22, wherein the liquid-applied foam material comprises polyurea.

26. The blast damage suppression material of claim 22, wherein the spray-applied foam material comprises a layer of polyurethane.

27. The blast damage suppression material of claim 22, wherein the spray-applied foam material comprises polyurea.

28. The blast damage suppression material of claim 23, wherein the polyurea, polyurethane or epoxy coating is applied to the exposed or outside surface of the polyurethane foam.

29. The blast damage suppression material of claim 23, wherein the polyurea, polyurethane or epoxy coating is applied to the non-exposed or inside surface of the polyurethane foam.

30. The blast damage suppression material of claim 23, wherein the polyurea, polyurethane or epoxy coating is applied to both the exposed and the non-exposed surfaces of the polyurethane foam.

31. The blast damage suppression material of claim 26, wherein the polyurethane foam is at least about two inches in thickness.

32. The blast damage suppression material of claim 26, wherein the polyurethane foam is at least about three inches in thickness.

33. The blast damage suppression material of claim 26, wherein the polyurethane foam is at least about four inches in thickness.

34. The blast damage suppression material of claim 26, wherein the polyurethane foam is at least about five inches in thickness.

35. The blast damage suppression material of claim 26, wherein the polyurethane foam is at least about six inches in thickness.

36. The blast damage suppression material of claim 22, further comprising a ballistic fabric material.

37. The blast damage suppression shielding material of claim 36, wherein the ballistic fabric material is directly applied to the cellular plastic material or polyurethane foam.

38. The blast damage suppression material of claim 36, wherein the ballistic fabric material is directly applied to the coating material.
